(19) United States
(12) Patent Application Publication
(10) Pub. No.: US 2025/0245566 A1
(43) Pub. Date: Jul. 31, 2025

(54) LEARNING APPARATUS, LEARNING METHOD, AND PROGRAM

(71) Applicant: NIPPON TELEGRAPH AND TELEPHONE CORPORATION, Tokyo (JP)

(72) Inventor: Hidetoshi KAWAGUCHI, Tokyo (JP)

(21) Appl. No.: 18/854,318

(22) PCT Filed: May 24, 2022
(86) PCT No.: PCT/JP2022/021307

§ 371 Date: Oct. 4, 2024

(51) Int. Cl. G06N 20/00; G06F 18/2415

(52) U.S. Cl. CPC G06N 20/00; G06F 18/2415

(57) ABSTRACT

A learning apparatus for training a machine learning model that outputs information to be used for estimating a classification probability for each class, the learning apparatus including a classification estimation process observation part that generates an estimation process feature vector based on data of an estimation process in classification of data, and a training part that trains the machine learning model by having a feature vector list obtained by adding at least a second estimation process feature vector obtained from data different from classification object data to a first estimation process feature vector obtained from the classification object data as input to the machine learning model, and by using a classification ratio vector list in which at least a second classification ratio vector different from a first classification ratio vector, being a correct answer to the classification object data, has been added to the first classification ratio vector as a correct answer to the input to the machine learning model.

### TECHNICAL FIELD

The present invention relates to a technology for classifying information. As an example of the field to which the present technology is applied, there is a technology that automatically classifies threat information by using a machine learning technology or the like, by a security operation entity that handles a security system against cyberattacks, such as an Intrusion Prevention System (IPS) and anti-virus software.

### BACKGROUND ART

A security operation entity handling a security system against cyberattacks classifies attackers, actions and techniques of attackers, vulnerabilities, and the like of cyberattack activities as threat information. Since such threat information needs to be generated day by day, the security operation entity needs to continuously and sequentially classify the threat information.

Examples of the related art for classification include, for example, those disclosed in PTL 1 and PTL 2. In the related art, a technique for automatically determining whether data classification is correct or incorrect has been proposed, and thus, it is possible to semi-automate the data classification operation by entrusting a person with the work of classifying data considered to be an error.

### CITATION LIST

### Patent Literature

PTL 1: Japanese Patent Application Publication No. 2020-024513
PTL 2: Japanese Patent Application Publication No. 2020-160642

### SUMMARY OF INVENTION

### Technical Problem

Although data classification can be performed and whether the data classification is correct can be determined with high accuracy in the related art, there is a problem that the probability of data belonging to each classification classes cannot be output.

The present invention has been conceived in light of the foregoing issue, and aims to provide a technique in which the probability of certain data belonging to each class can be output, in addition to making determination of classification of the data to be correct or incorrect.

### Solution to Problem

According to the disclosed technique, a learning apparatus for training a machine learning model that outputs information to be used for estimating a classification probability for each class is provided, and the learning apparatus includes a classification estimation process observation part that generates an estimation process feature vector based on data of an estimation process in classification of data, and a training part that trains the machine learning model by having a feature vector list obtained by adding at least a second estimation process feature vector obtained from data different from classification object data to a first estimation process feature vector obtained from the classification object data as input to the machine learning model, and by using a classification ratio vector list in which at least a second classification ratio vector different from a first classification ratio vector, being a correct answer to the classification object data, has been added to the first classification ratio vector as a correct answer to the input to the machine learning model.

### Advantageous Effects of Invention

According to the disclosed technique, it is possible to output the probability of certain data belonging to each class in addition to making determination of classification of the data to be correct or incorrect.

### BRIEF DESCRIPTION OF DRAWINGS

FIG. 1 is a diagram for describing an overview of an embodiment of the present invention.

FIG. 2 is a diagram for describing an overview of an embodiment of the present invention.

FIG. 3 is a configuration diagram of a classification device according to an embodiment of the present invention.

FIG. 4 is a flowchart for describing a method for creating a classification probability correction vector calculator.

FIG. 5 is a diagram illustrating a hardware configuration example of a device.

### DESCRIPTION OF EMBODIMENTS

An embodiment of the present invention (the present embodiment) will be described below with reference to the drawings. The embodiments to be described below are merely exemplary and an embodiment to which the present invention is applied is not limited to the following embodiments.

### (Overview of Embodiment)

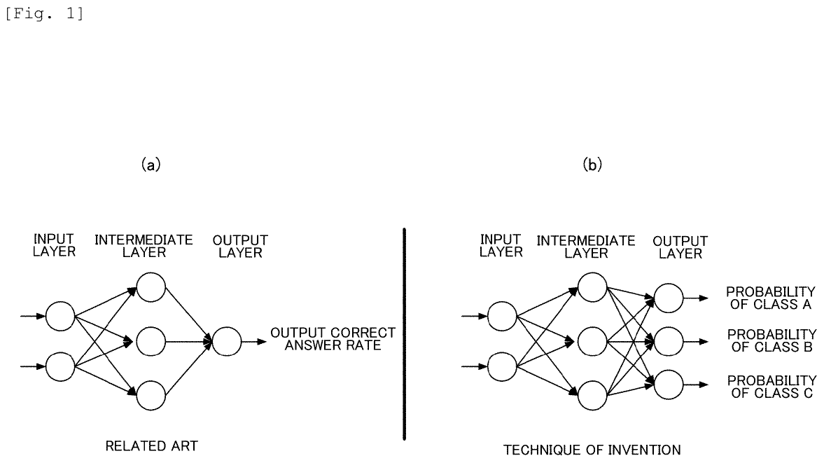

An overview of the present embodiment will be described with reference to FIG. 1. FIG. 1(a) illustrates an image of the prior art, and only one correct answer rate is output from a function (neural network) for calculating a certainty factor of classification.

In contrast, in the technique according to the present embodiment illustrated in FIG. 1(b), the function for calculating a certainty factor of classification outputs all the probabilities of data belonging to each class.

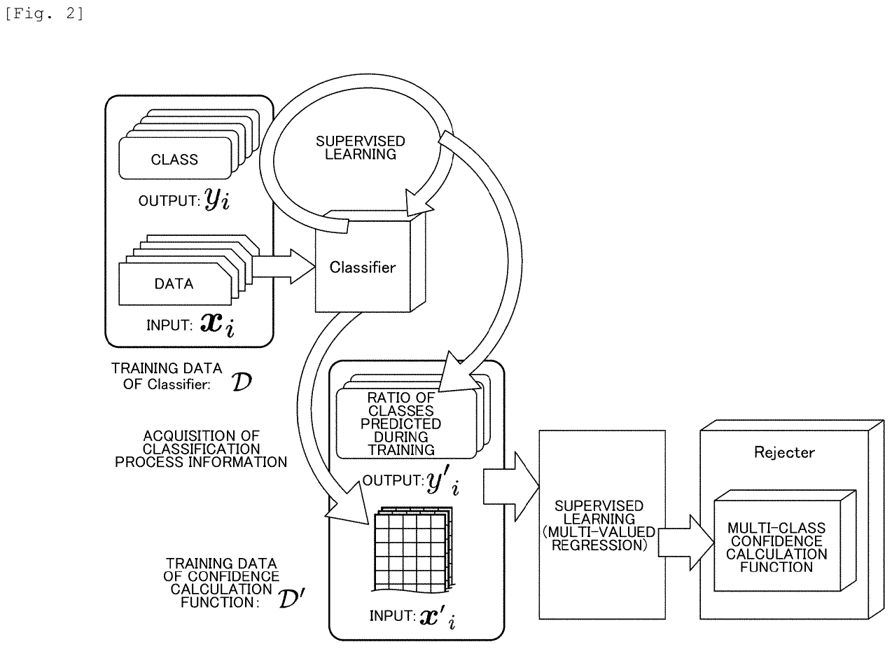

FIG. 2 schematically illustrates an overview of details of processing performed by a classification device according to the present embodiment. A classifier (corresponding to a classification estimation part 110 to be described later) performs learning by using input data and a class to be a correct answer. At the time of learning, the classification estimation part 110 predicts the class of data repeatedly. The percentage of predicted classes is used as training data of a multi-class certainty factor calculation function (corresponding to a classification probability correction vector calculator 122 to be described later) in the rejecter.

For example, for a given data point, if during supervised learning the classifier predicts class A 70 times, Class B 20 times, and Class C 10 times, the resulting label would be [0.7, 0.2, 0.1], representing the percentages of the predictions.

The percentage of the class (the label) predicted here is used as correct answer data to learn a multi-class certainty factor calculation function. Thus, a multi-class certainty factor calculation function (classification probability correction vector calculator 122) capable of predicting a probability of certain data belonging to each class with high accuracy can be obtained.

In addition, in the present embodiment, as learning is performed by additionally using a feature vector obtained from data that is not similar to classification object data at the time of learning by the classification probability correction vector calculator 122, the performance of getting the probability of unknown data for each class to be close to a uniform distribution can be improved.

A configuration and an operation of the classification device according to the present embodiment will be described in detail below.

### Device Configuration Example

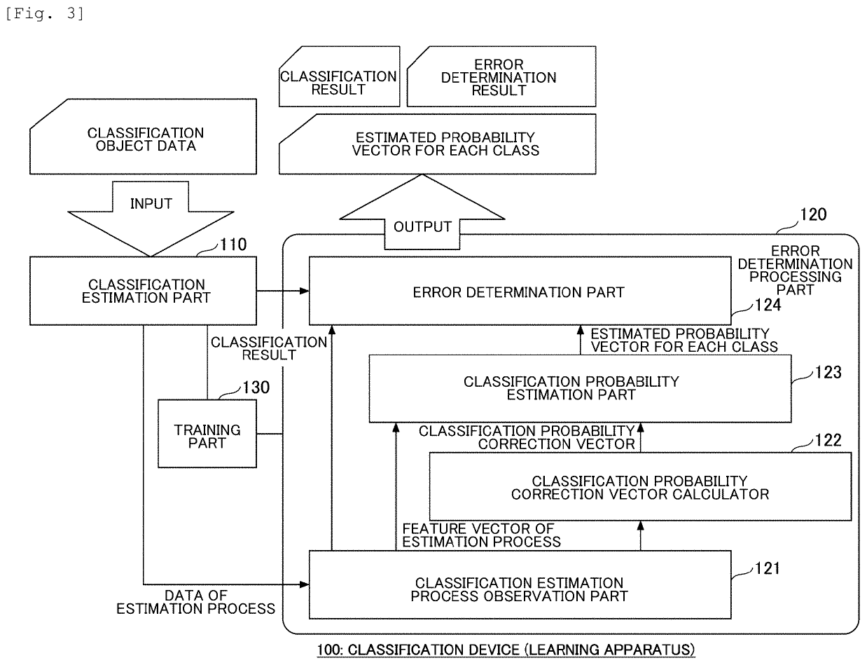

FIG. 3 illustrates a function configuration diagram of a classification device 100 according to an embodiment of the present invention. As illustrated in FIG. 3, the classification device 100 includes a classification estimation part 110 and an error determination processing part 120. The error determination processing part 120 includes a classification estimation process observation part 121, the classification probability correction vector calculator 122, a classification probability estimation part 123, and an error determination part 124.

In addition, the classification device 100 may include a training part 130. The training part 130 executes a learning operation such as parameter adjustment in supervised learning by the classification estimation part 110, the classification probability correction vector calculator 122 and the like. Note that in the state with learning completed, the training part 130 need not be included. Furthermore, a device including the training part 130 shown in FIG. 3, may be called a learning apparatus.

Note that the classification estimation part 110 and the error determination processing part 120 may be included in separate devices, and may be connected by a network, and in this case, the error determination processing part 120 may be referred to as an error determination device. In addition, a device including the classification estimation part 110 and the error determination processing part 120 may be referred to as an error determination device. An overview of an operation of each part of the classification device 100 at the time of inference will be described below.

### (Overview of Operation)

First, classification object data is input to the classification estimation part 110. The classification object data is classification object data in some way by using the present system, and is, for example, threat information.

The classification estimation part 110 estimates classification of classification object data. Although an artificial intelligence-related technique such as SVM/neural network is assumed for the method and model for estimation, the embodiment is not limited to these techniques.

The classification estimation process observation part 121 observes the calculation process of when the classification estimation part 110 estimates classification object data, converts it into a feature vector (feature vector of the estimation process), and outputs the feature vector.

The classification probability correction vector calculator 122 receives the feature vector of the estimation process from the classification estimation process observation part 121, and calculates a vector for correcting the classification probability. The classification probability correction vector calculator 122 is created by machine learning. The creation method will be described later.

The classification probability correction vector output from the classification probability correction vector calculator 122 is a numeric vector used for correcting the classification probability, and is a real-valued vector having a class number dimension. Note that the classification probability correction vector itself output from the classification probability correction vector calculator 122 may be used as a vector of a probability of classification object data belonging to each class (an estimated probability vector for each class).

The classification probability estimation part 123 receives the feature vector of the estimation process from the classification estimation process observation part 121, receives the classification probability correction vector from the classification probability correction vector calculator 122, and calculates the probability of the classification object data belonging to each class. There are a plurality of implementation methods, and details will be described below. The feature vector of the estimation process, a part of the feature vector of the estimation process, or the classification probability correction vector may be output as it is. That is, the classification probability correction vector calculator 122 may be used as the classification probability estimation part 123, without providing the classification probability estimation part 123.

The classification probability correction vector calculator 122 and the classification probability estimation part 123 may be collectively referred to as a “probability estimation part”. The functional unit including the classification probability correction vector calculator 122 and the classification probability estimation part 123 may be collectively referred to as a “probability estimation part”.

The error determination part 124 receives the classification result, the feature vector of the estimation process, and the estimation probability for each classification from the classification estimation part 110, the classification estimation process observation part 121, and the classification probability estimation part 123, respectively, and determines whether the classification estimated by the classification estimation part 110 is “correct” or “incorrect” based on the received information. In addition, the error determination part 123 outputs the error determination result, the classification result, and an estimated probability vector for each class as a result of the whole system. It is also acceptable to output only some of the error determination result, the classification result, and the estimated probability vector for each class. For example, only the estimated probability vector for each class may be output.

The classification result is a classification result of the classification object data, and indicates one or more “classes” determined from a predetermined class (classification) list.

The estimated probability vector for each class is the probability value of each class output by the classification probability estimation part 123. For example, in a case that certain data is assumed to be classified into classes A, B and C, the probability of classification into A is ∘%, the probability with respect to B is □% and the probability with respect to C is Δ%. The error determination result is a determination result of whether the classification has an error.

Hereinafter, the processing operation of each part of the error determination processing part 120 will be described in detail.

### (Classification Estimation Process Observation Part 121)

First, the classification estimation process observation part 121 will be described. The classification estimation process observation part 121 observes the calculation process (data of an estimation process) when the classification estimation part 110 estimates classification object data, then configure a feature vector (feature vector of the estimation process), and outputs the feature vector.

Configured feature vectors basically vary depending on the model used in the classification estimation part 110. Here, the following (1), (2), and (3) will be described as examples of typical feature vectors.

(1) A Feature Vector that can be Configured in Common by an Arbitrary Classification Estimation Module (Classification Estimation Part)

Examples of feature vectors that can be commonly configured by an arbitrary classification estimation module include the following (1-1) and (1-2).

(1-1) A Feature Vector Obtained by Converting Classification Object Data into a Numeric Vector

In a case that the classification estimation part 110 has been constructed by means of a machine learning model, classification object data has been converted into a feature vector that is a numeric vector inside. The numeric vector is observed to be set to a feature vector in an estimation process. More specifically, as in the method disclosed in PTL 2, for example, a feature vector may be configured by concatenating the values of the nodes in the intermediate layer and the values of the nodes in the output layer in a neural network corresponding to the classification estimation part 110.

### (1-2) Estimated Probability Vector for Each Estimated Class

In a case that the classification estimation part 110 is constructed by means of a machine learning model for performing multi-class classification, scoring of classification is performed for each class. The scoring is observed, and the scoring is converted into probability values and arranged to obtain a probability vector for each estimated class, and the probability vector is set as a feature vector of an estimation process.

Specifically, the classification estimation process observation part 121 converts a score (real value) of each class obtained by observing the classification estimation part 110 into a vector of a probability by using a softmax function. That is, when the score of each class is set to a₁, . . . , aₙ at the time of n-class classification, a probability pₖ of class k can be calculated, for example, as follows.

$${p}_{k} = \frac{{e}^{{a}_{k}}}{{\sum }_{i = 1}^{n} {e}^{{a}_{i}}} \qquad [ Math . 1 ]$$

### (2) Logit Vector

In a case that the classification estimation part 110 performs class classification by using a neural network, the classification estimation part 110 basically estimates a probability vector for each classification (class) from the score for each class with respect to input data. This procedure is the same as the procedure of the “probability vector for each estimated class” described above, in which the softmax function is applied to the scores a₁, . . . , aₙ of each class. The classification estimation process observation part 121 observes a₁, . . . , aₙ from the classification estimation part 110 and sets them as feature vectors of the estimation process.

In addition, a prediction score of an arbitrary classifier may be used as a feature vector of the estimation process. For example, in a case that the classification estimation part 110 performs class classification by using support vector machine (SVM), the distance to the boundary surface can be observed as a prediction score, and this can be used as a feature vector of the estimation process.

### (3) Feature Vector of Ensemble Classifier

In a case that the classification estimation part 110 is configured by using a plurality of machine learning models, any one or a plurality of the above-mentioned “feature vector obtained by converting classification object data into a numeric vector”, “probability vector for each estimated class”, and “logit vector” can be acquired in each of machine learning models. A vector obtained by concatenating the vectors of the plurality of machine learning models can be output as a feature vector of the estimation process.

### (Error Determination Part 124)

Next, the error determination part 124 will be described. As illustrated in FIG. 3, the error determination part 124 receives the classification result, the feature vector of the estimation process, and the estimation probability for each class, and determines whether the classification estimated by the classification estimation part 110 is “correct” or “incorrect” based on the received information. Note that, in the determination, only one of the feature vector of the estimation process and the estimation probability for each class may be used.

In addition, the error determination part 124 outputs the error determination result, the classification result, and the estimation probability vector for each class as a result of the whole system.

Although the error determination method executed by the error determination part 124 is not limited to a specific method, for example, any one of the following methods 1 to 3 can be used. Any two or all of the three methods 1 to 3 may be combined for application. In addition, the following three methods 1 to 3 are examples, and a method other than the following three methods 1 to 3 may be used.

### [Method 1]

In method 1, the error determination part 124 determines a threshold of an index called a certainty factor.

Specifically, the error determination part 124 acquires a maximum value among estimation probabilities of classes, and defines the maximum value as a certainty factor. When the certainty factor is equal to or greater than a set threshold, the classification result to the class is determined to be “correct”, and when the certainty factor is less than the set threshold, the classification result is determined to be “incorrect”.

In addition, in the calculation of a certainty factor, the user can arbitrarily set arbitrary calculation using any one of a classification result, a feature vector of an estimation process, and an estimated probability of each class for the error determination part 124.

For example, the error determination part 124 may set a difference (m1−m2) between the maximum value (m1) of the estimated probability of each class and the second largest value (m2) as a certainty factor. The maximum value, the third largest value, the fourth largest value, . . . , and the estimated probability of an arbitrary rank can be calculated in the same manner.

### [Method 2]

In method 2, the error determination part 124 determines a threshold of an index called an uncertainty. Specifically, the error determination part 124 calculates an average information amount (entropy) of the estimated probability of each class, and defines the value as an uncertainty. When the uncertainty is equal to or greater than a set threshold, the classification result is determined to be “incorrect”, and when the uncertainty is less than the threshold, the classification result is determined to be “correct”.

If the probabilities of respective classes are set to is p₁, . . . , and pₙ in n-class classification, the average information amount can be calculated as follows.

$$u = - {\sum }_{i = 1}^{n} {p}_{i} log {p}_{i} \qquad [ Math . 2 ]$$

In addition, in calculation of an uncertainty, the user can arbitrarily set arbitrary calculation using any one of a classification result, a feature vector of an estimation process, and an estimated probability of each class for the error determination part 124.

### [Method 3]

Determination may be made by the error determination part created through machine learning similarly that in the related art disclosed in PTL 1 and PTL 2. Furthermore, it is also possible to perform the determination by using any related art other than the related art disclosed in PTL 1 and PTL 2.

### (Classification Probability Estimation Part 123)

Next, the classification probability estimation part 123 will be described in detail. As illustrated in FIG. 3, the classification probability estimation part 123 receives a feature vector and a classification probability correction vector of an estimation process, and calculates an estimated probability vector for each class. Although the implementation method is not limited to a particular method, methods 1 to 3 described below can be used, for example. Note that, the method that can be implemented depends on what is included in the feature vector of the estimation process.

### [Method 1]

When the “estimation probability of each class” is included in the feature vector of the estimation process, the classification probability estimation part 123 cuts out the “estimation probability of each class” and outputs the result as an estimation probability vector for each class. In this case, the cut “estimated probability of each class” may be output as it is, or the result corrected with a classification probability correction vector may be output. The correction may be, for example, an average of the cut “estimated probability of each class” and the estimated probability of each class in the classification probability correction vector, or may be one subjected to other processing.

### [Method 2]

In the method 2, the classification probability estimation part 123 outputs a classification probability correction vector as an estimated probability vector for each class as it is. In this case, the classification probability correction vector calculator 122 may be used as the classification probability estimation part 123, without providing the classification probability estimation part 123.

### [Method 3]

In the method 3, when a feature vector of the estimation process includes a “logit vector” shown in (2) of the above-described classification estimation process observation part 121, an estimated probability vector for each class is calculated by any one of the following methods 3-1 and 3-2.

### [Method 3-1]

When logit vectors are [a₁, . . . , aₙ]^{T} and classification probability correction vectors are [b₁, . . . , bₙ]^{T} in n-class classification, the probability pₖ of the class k can be calculated as follows.

$${p}_{k} = \frac{{e}^{{a}_{k} {b}_{k}}}{{\sum }_{i = 1}^{n} {e}^{{a}_{i} {b}_{i}}} \qquad [ Math . 3 ]$$

This pₖ is calculated for all classes, and vectors [p₁, . . . , pₙ]^{T} are used as estimated probability vectors for each class.

### [Method 3-2]

Logit vectors are [a₁, . . . , aₙ]^{T} and classification probability correction vectors are [b₁, . . . , bₙ]^{T} in n-class classification, The maximum value bₘₐₓ of the elements in the classification probability correction vectors is acquired, and the probability pₖ of the class k is calculated as follows.

$${p}_{k} = \frac{{e}^{{a}_{k} {b}_{max}}}{{\sum }_{i = 1}^{n} {e}^{{a}_{i} {b}_{max}}} \qquad [ Math . 4 ]$$

This pₖ is calculated for all classes, and vectors [p₁, . . . , pₙ]^{T} are used as estimated probability vectors for each class.

### (Classification Probability Correction Vector Calculator 122)

Next, the classification probability correction vector calculator 122 will be described in detail. As shown in FIG. 3, the classification probability correction vector calculator 122 receives feature vectors of the estimation process, calculates and outputs the classification probability correction vectors. The classification probability correction vectors are n-dimensional real value vectors in n-class classification.

The classification probability correction vector calculator 122 is constructed by a machine learning model capable of estimating a plurality of real values. The generation method (parameter tuning method) of the classification probability correction vector calculator 122 will be described below.

As a machine learning model capable of estimating a plurality of real values used as the classification probability correction vector calculator 122, for example, a neural network, logistic regression, support vector regression (SVR), and the like can be used.

When a neural network is used as the classification probability correction vector calculator 122, a plurality of real values can be estimated by a single model. However, logistic regression and SVR cannot estimate a plurality of real values alone. In such a case, n machine learning models are prepared to infer real values corresponding to each class.

Note that a neural network, logistic regression, support vector regression, and the like are merely examples, and an arbitrary machine learning model can be used as long as it has a structure capable of estimating a plurality of real values by using the machine learning model.

### (Generation Method for Classification Probability Correction Vector Calculator 122)

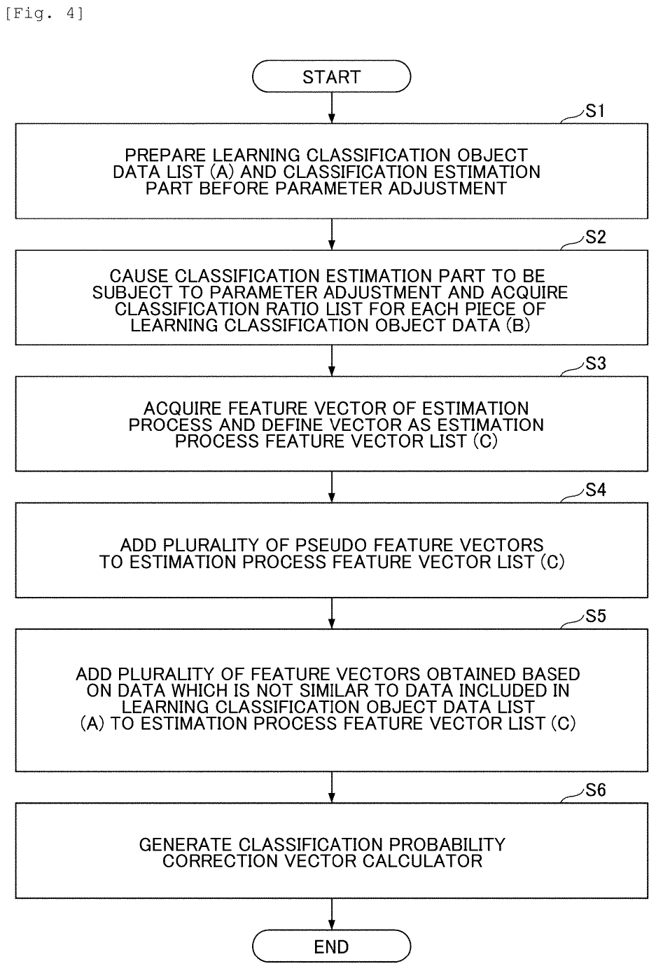

Next, a generation method for the classification probability correction vector calculator 122 (parameter adjustment method, learning method of a machine learning model) will be described with reference to the procedure of the flowchart of FIG. 4. Here, the number of classifications is assumed to be n. In the following description, (A) is given to the “learning classification object data list”, (B) is given to the “classification ratio list for each piece of learning classification object data”, and (C) is given to the “estimation process feature vector list” in order to make the description easy to understand. Note that the classification ratio for each piece of learning classification object data may be called a classification ratio vector.

In the following description, it is assumed that each part is implemented by a neural network, but this is merely an example.

Furthermore, the processing related to the following learning is executed by the training part 130. The training part 130 includes a function of holding learning data (memory or the like), a parameter adjustment function (a function of executing an error reverse propagation method or the like), and the like. A device having the training part 130, the classification estimation process observation part 121, and the classification probability correction vector calculator 122 may be called a learning apparatus 100.

### <S1>

In S1 (step 1), the learning classification object data list (A) and the classification estimation part 110 before parameter adjustment are prepared and held in the training part 130. The learning classification object data list (A) is a data list, and if there are two pieces of data, the list is in the form of [data 1, data 2].

### <S2>

The classification estimation part 110 performs parameter adjustment by using a general supervised learning method. In the process, the training part 130 acquires the classification ratio list for each piece of learning classification object data (B). The classification ratio list for each piece of learning classification object data (B) will be described.

In general supervised learning, of which a neural network is a typical example, data classification is performed repeatedly in that process. Through the repetition, the ratios of classification of each piece of the learning classification object data are made into a list to be the classification ratio list for each piece of learning classification object data (B).

For example, in a case of three-class classification, the neural network is assumed to classify data 1 and data 2 one hundred times in the process of learning. In this process, it is assumed that the data 1 is classified to class 1 fifty times, to class 2 thirty times, and to class 3 twenty times. In addition, it is assumed that the data 2 is classified to class 1 ten times, to class 2 seventy times, and to class 3 twenty times. In this case, the classification ratio list for each piece of learning classification object data (B) is [[0.5, 0.3, 0.2]^{T}, [0.1, 0.7, 0.2]^{T}]. Note that, in the following description, in order to simplify the description, it is assumed that the symbol T of transposition is not described even when the vector is transposed.

### <S3>

In S3, each element of the learning classification object data list (A) is input to a classification estimation part 110 parameter-adjusted in S2, a feature vector of an estimation process is acquired by a classification estimation process observation part 121, and it is defined as an estimation process feature vector list (C).

For example, when the learning classification object data list (A) is assumed to be a list of [data 1, data 2] consisting of two elements, data 1 is input to the classification estimation part 110, a feature vector of the estimation process is acquired by the classification estimation process observation part 121, data 2 is input to the classification estimation part 110, and a feature vector of the estimation process is acquired by the classification estimation process observation part 121.

As an example, if the feature vectors for data 1 are [0.5, 0.4, 0.7, 0.2], and the feature vectors for data 2 are [0.3, 0.2, 0.8, 0.1], the estimation process feature vector list (C) is [[0.5, 0.4, 0.7, 0.2], [0.3, 0.2, 0.8, 0.1]].

### <S4>

In S4, a plurality of pseudo feature vectors generated with random numbers or the like are added to the estimation process feature vector list (C). In addition, n-dimensional vectors with all elements set to 1/n are added to the classification ratio list for each piece of learning classification object data (B) by the same number as the number of pseudo feature vectors added to (C). For example, when three-class classification is performed, the vectors added to (B) are [1/3, 1/3, 1/3]. It is assumed that the number of vectors to be added is set by the user of the classification device.

For example, if two pseudo feature vectors [1.0, 0.8, 0.5, 0.1] and [0.1, 0.3, 0.9, 0.0] are added to the estimation process feature vector list (C) [[0.5, 0.4, 0.7, 0.2], [0.3, 0.2, 0.8, 0.1]], the estimation process feature vector list (C) after the addition is [[0.5, 0.4, 0.7, 0.2], [0.3, 0.2, 0.8, 0.1], [0.1, 0.8, 0.5, 0.1], [0.1, 0.3, 0.9, 0.0]].

In addition, in this case, two n-dimensional vectors each having all elements set to 1/n are added to the classification ratio list for each piece of learning classification object data (B). If n=3, and the classification ratio list for each piece of learning classification object data (B) at present is [[0.5, 0.3, 0.2], [0.1, 0.7, 0.2]], the classification ratio list for each piece of learning classification object data (B) after the addition is [[0.5, 0.3, 0.2], [0.1, 0.7, 0.2], [1/3, 1/3, 1/3], [1/3, 1/3, 1/3]].

By performing addition as described above, random feature vectors become robust, and the accuracy of classification of threat information or the like having unknown features is improved.

Here, although each element of the n-dimensional vectors to be added to the classification ratio list for each piece of learning classification object data (B) is set to 1/n, each element may be an arbitrary value. For example, each element may be set to 0.

### <S5>

Here, although the processing of S5 is performed after S4, the processing of S5 may be performed before S4 (after S3). In addition, S5 may be performed without S4.

In S5, arbitrary data that is not similar to the data included in the learning classification object data list (A) is input to the classification estimation part 110, and thereby a plurality of feature vectors obtained from a classification estimation process observation part 121 are added to the estimation process feature vector list (C).

In addition, n-dimensional vectors with all elements set to 1/n are added to the classification ratio list for each piece of learning classification object data (B) by the same number as the number of feature vectors added to the estimation process feature vector list (C).

For example, if the number of vectors to be added is set to 2, and two feature vectors [0.0, 0.4, 0.5, 0.3] and [0.9, 0.3, 0.1, 0.5] are obtained by the classification estimation process observation part 121 from “two pieces of data that are not similar to data included in the learning classification object data list (A)” and they are added to the estimation process feature vector list (C) at present [[0.5, 0.4, 0.7, 0.2], [0.3, 0.2, 0.8, 0.1], [0.1, 0.8, 0.5, 0.1], [0.1, 0.3, 0.9, 0.0]], the estimation process feature vector list (C) after the addition is [[0.5, 0.4, 0.7, 0.2], [0.3, 0.2, 0.8, 0.1], [0.1, 0.8, 0.5, 0.1], [0.1, 0.3, 0.9, 0.0], [0.0, 0.4, 0.5, 0.3], [0.9, 0.3, 0.1, 0.5]].

In addition, in this case, two n-dimensional vectors each having all elements set to 1/n are added to the classification ratio list for each piece of learning classification object data (B). Because n=3, and the classification ratio list for each piece of learning classification object data (B) at present is [[0.5, 0.3, 0.2], [0.1, 0.7, 0.2], [1/3, 1/3, 1/3], [1/3, 1/3, 1/3]], the classification ratio list for each piece of learning classification object data (B) after the addition is [[0.5, 0.3, 0.2], [0.1, 0.7, 0.2], [1/3, 1/3, 1/3], [1/3, 1/3, 1/3], [1/3, 1/3, 1/3], [1/3, 1/3, 1/3]].

Here, although each element of the n-dimensional vectors to be added to the classification ratio list for each piece of learning classification object data (B) is set to 1/n, each element may be an arbitrary value. For example, each element may be set to 0.

Note that, in each of S4 and S5, a user may set values of respective elements of the n-dimensional vectors to be added to the classification ratio list for each piece of learning classification object data (B) in consideration of a method of implementing the classification probability correction vector calculator 122 or the classification probability estimation part 123.

Specifically, for example, when the classification probability correction vector outputted from the classification probability correction vector calculator 122 is a probability vector (the total of elements becomes 1), the value of each element of the n-dimensional vectors is set to 1/n. When it is not necessary that the total of the elements of the classification probability correction vectors output by the classification probability correction vector calculator 122 is 1, the value of each element of the n-dimensional vectors may be zero or the same value of each element other than 0.

In addition, for example, when the method of implementing the classification probability estimation part 123 is the above-described [Method 2], the value of each element of the n-dimensional vectors is set to 1/n. In addition, for example, when the method of implementing the classification probability estimation part 123 is the above-mentioned [Method 3-1] or [Method 3-2], if the classification probability correction vector is a probability vector, the value of each element of the n-dimensional vectors is set to 1/n, if there is no assumption that the correction vector is a probability vector, the value of each element of the n-dimensional vectors is set to zero. By setting the value of each element of the n-dimensional vector to zero, the effect of making the classification probability for the unknown data uniform distribution can be enhanced.

### <S6>

In S6, the estimation process feature vector list (C) processed in S5 is input, and the classification ratio list for each piece of learning classification object data (B) processed in S5 is output (correct answer), and thereby the classification probability correction vector calculator 122 is generated in supervised learning. In other words, the parameter of the classification probability correction vector calculator 122 is adjusted in supervised learning.

When the example of S5 is used, the estimation process feature vector list (C) is [[0.5, 0.4, 0.7, 0.2], [0.3, 0.2, 0.8, 0.1], [0.1, 0.8, 0.5, 0.1], [0.1, 0.3, 0.9, 0.0], [0.0, 0.4, 0.5, 0.3], [0.9, 0.3, 0.1, 0.5]], and the classification ratio list for each piece of learning classification object data (B) is [[0.5, 0.3, 0.2], [0.1, 0.7, 0.2], [1/3, 1/3, 1/3], [1/3, 1/3, 1/3], [1/3, 1/3, 1/3], [1/3, 1/3, 1/3]]. In order to make the description easy to understand here, assuming that the vector of each element in the input list is represented by xi, and the vector of each element in the output (correct answer) list is represented by yi, the following will be described.

The estimation process feature vector list (C) (input) is [[0.5, 0.4, 0.7, 0.2], [0.3, 0.2, 0.8, 0.1], [0.1, 0.8, 0.5, 0.1], [0.1, 0.3, 0.9, 0.0], [0.0, 0.4, 0.5, 0.3], [0.9, 0.3, 0.1, 0.5]]=[x1, x2, x3, x4, x5], and the classification ratio list for each piece of learning classification object data (B) (correct answer) is [[0.5, 0.3, 0.2], [0.1, 0.7, 0.2], [1/3, 1/3, 1/3], [1/3, 1/3, 1/3], [1/3, 1/3, 1/3], [1/3, 1/3, 1/3]]=[y1, y2, y3, y4, y5].

Here, when the model (classification probability correction vector calculator 122) is expressed by f, the parameter of f is adjusted such that y1=f(x1), y2=f(x2), y3=f(x3), y4=f(x4), y5=f(x5), and y6=f(x6) are satisfied through the learning of S6.

### (Regarding Data Used in S5)

The “arbitrary data that is not similar to the data included in the learning classification object data list” in S5 described above refers to, for example, the following data.

For example, when a data set of handwritten numeral identification called MNIST is defined as a learning classification object data list, the data set called Fashion-MNIST or CIFAR10 is an example of the “arbitrary data that is not similar to the data included in the learning classification object data list”.

Although MNIST is composed of handwritten numeral images of 0, 1, 2, . . . , and 9, Fashion-MNIST is a data set composed of images of clothes such as shirts and dresses, and CIFAR10 is a data set composed of images of dogs, vehicles, etc. As described above, it is preferable that the difference between “data that is not similar to the data included in the learning classification object data list” and “data included in the learning classification object data list” is greater. The “difference” may be a difference in the type of data, a difference in an appearance of data (a large difference in appearance, etc. although the data is the same type of image), or may be a difference in an element other than these. The “type of data” may be a type of one represented by an image, such as an example of MNIST, Fashion-MNIST, or CIFAR10, and it may be a type representing a difference in data format (pixel, character code, etc.) expressed by a computer, such as an image and text.

Furthermore, no label indicating a class is required for “arbitrary data that is not similar to the data included in the learning classification object data list”.

### (Exemplary Hardware Configuration)

The classification device 100, the learning apparatus, and the error determination device, and the like described above can be implemented, for example, by causing a computer to execute a program describing the processing details described in the present embodiment. The computer may be a physical computer or a virtual machine on a cloud. Hereinafter, the classification device 100, the learning apparatus, the error determination device, and the like are generally called “devices”.

That is, the device can be implemented by executing a program corresponding to the processing performed by the device using hardware resources such as a CPU and a memory contained in a computer. The foregoing program can be recorded on a computer-readable recording medium (a portable memory or the like) to be stored or distributed. The foregoing program can also be provided through a network such as the Internet or an e-mail.

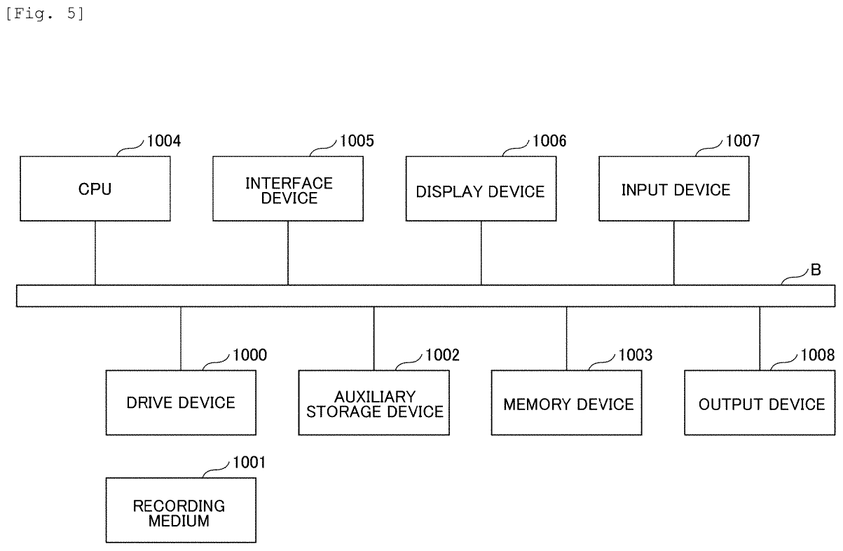

FIG. 5 is a diagram illustrating a hardware configuration example of the computer. The computer shown in FIG. 5 includes a drive device 1000, an auxiliary storage device 1002, a memory device 1003, a CPU 1004, an interface device 1005, a display device 1006, an input device 1007, and an output device 1008 which are connected to each other via a bus BS.

The program for implementing the processing in the computer is provided by, for example, a recording medium 1001 such as a CD-ROM or a memory card. When the recording medium 1001 in which the program is stored is set in the drive device 1000, the program is installed from the recording medium 1001 to the auxiliary storage device 1002 through the drive device 1000. However, the program need not necessarily be installed from the recording medium 1001 and may be downloaded from another computer via a network. The auxiliary storage device 1002 stores the installed program and also stores necessary files, data, and the like.

The memory device 1003 reads and stores the program from the auxiliary storage device 1002 when an instruction to start the program is given. The CPU 1004 implements a function related to the device in accordance with the program stored in the memory device 1003. The interface device 1005 is used as an interface for connection to a network or the like. The display device 1006 displays a graphical user interface (GUI) or the like by the program. The input device 1007 is configured with a keyboard, a mouse, a button, a touch panel, or the like, and is used to input various operation instructions. The output device 1008 outputs a calculation result.

### (Effects of Embodiments)

According to the technique according to the present embodiment, it is possible to output a probability for each class with respect to certain data in addition to the determination of correctness. For example, a case in which certain data is classified into classes A, B, and C is assumed. The classification device 100 can estimate the probability of the data being classified into class A to be ∘%, the probability of the data being classified into class B to be □%, and the probability of the data being classified into class C as Δ%, and can present the estimation to a person.

In addition, in the technique according to the present embodiment, the ratio of the classification estimated during learning is acquired for each piece of learning data during learning by the classification estimation part 110, and the ratio is used for training by the classification probability correction vector calculator 122. With the above configuration, accuracy in determination of correctness is improved as compared with the technology in the related art, and accuracy in estimation of a probability for each class estimated in the system is improved.

### (Regarding Effects of Classification Probability Correction Vector Calculator 122)

When classification of unknown data (data generated from sources out of distribution of learning data) is estimated, error determination and accuracy in estimation of a probability for each class is thought to be reduced. For example, although the model is trained to classify the handwritten numeral images of 0 to 9 into any of classes (10 classifications) of 0 to 9, estimation accuracy is thought to be reduced when an image other than handwritten numeral images of 0 to 9, such as a photograph of a vehicle, has been acquired. Here, although it is originally preferable that it is determined to be “incorrect” in the error determination and the estimation accuracy for each class be estimated to be [1/10, 1/10, . . . , 1/10], there may be cases where this is not the case.

Therefore, as described above, in the generation (learning) of the classification probability correction vector calculator 122 of the present embodiment, an estimation process feature vector based on “arbitrary data that is not similar to the data included in the learning classification object data list” (data without label acquired from a distribution different from learning data) is added as input data for training, and an n-dimensional vector having the same elements is added to the classification ratio list of correct answers corresponding to the addition.

Thus, it is possible to increase the probability of unknown data being determined to be “incorrect”, and to improve the performance of approximating the probability of the unknown data with respect to each class to a uniform distribution. For example, output can be performed such that the probability of the data being classified into class A is 25%, the probability of the data being classified into class B is 25%, the probability of the data being classified into class C is 25%, and the probability of the data being classified into class D is 25%.

### (Supplementary Notes)

The following supplementary items are disclosed in relation to the embodiment described above.

### (Supplementary Item 1)

A learning apparatus for training a machine learning model that outputs information to be used for estimating a classification probability for each class, the learning apparatus including
a memory, and
at least one processor connected to the memory,
in which
the processor
generates an estimation process feature vector based on data of an estimation process in classification of data, and
trains the machine learning model by having a feature vector list obtained by adding at least a second estimation process feature vector obtained from data different from classification object data to a first estimation process feature vector obtained from the classification object data as input to the machine learning model, and by using a classification ratio vector list in which at least a second classification ratio vector different from a first classification ratio vector, being a correct answer to the classification object data, has been added to the first classification ratio vector as a correct answer to the input to the machine learning model.

### (Supplementary Item 2)

The learning apparatus according to supplementary item 1, in which the data different from the classification object data is data that is not similar to the classification object data.

### (Supplementary Item 3)

The learning apparatus according to supplementary item 1 or 2, in which the second classification ratio vector is a classification ratio vector having the same value for the number of classes.

### (Supplementary Item 4)

A learning method performed by a learning apparatus for training a machine learning model that outputs information to be used for estimating a classification probability for each class, the learning method including
a classification estimation process observation step of generating an estimation process feature vector based on data of an estimation process in classification of data, and a training step of training the machine learning model by having a feature vector list obtained by adding at least a second estimation process feature vector obtained from data different from classification object data to a first estimation process feature vector obtained from the classification object data as input to the machine learning model, and by using a classification ratio vector list in which at least a second classification ratio vector different from a first classification ratio vector, being a correct answer to the classification object data, has been added to the first classification ratio vector as a correct answer to the input to the machine learning model.

### (Supplementary Item 5)

A non-transitory storage medium storing a program for causing a computer to function as each part of the learning apparatus described in any one of supplementary items 1 to 3.

Although the embodiment has been described above, the present invention is not limited to the specific embodiment, and various modifications and changes can be made within the scope of the gist of the present invention described in the claims.

### REFERENCE SIGNS LIST

100 Classification device
110 Classification estimation part
120 Error determination processing part
121 Classification estimation process observation part
122 Classification probability correction vector calculator
123 Classification probability estimation part
124 Error determination part
130 Training part
1000 Drive device
1001 Recording medium
1002 Auxiliary storage device
1003 Memory device
1004 CPU
1005 Interface device
1006 Display device
1007 Input device
1008 Output device

1. A learning apparatus for training a machine learning model configured to output information to be used for estimating a classification probability for each class, the learning apparatus comprising:
a memory; and
a processor coupled to the memory and configured to:
generate an estimation process feature vector based on data of an estimation process in classification of data; and
train the machine learning model by having a feature vector list obtained by adding at least a second estimation process feature vector obtained from data different from classification object data to a first estimation process feature vector obtained from the classification object data as input to the machine learning model, and by using a classification ratio vector list in which at least a second classification ratio vector different from a first classification ratio vector, being a correct answer to the classification object data, has been added to the first classification ratio vector as a correct answer to the input to the machine learning model.

2. The learning apparatus according to claim 1,
wherein the data different from the classification object data is data that is not similar to the classification object data.

3. The learning apparatus according to claim 1,
wherein the second classification ratio vector is a classification ratio vector having the same value for the number of classes.

4. A learning method performed by a learning apparatus for training a machine learning model configured to output information to be used for estimating a classification probability for each class, the learning method comprising:
generating an estimation process feature vector based on data of an estimation process in classification of data; and
training the machine learning model by having a feature vector list obtained by adding at least a second estimation process feature vector obtained from data different from classification object data to a first estimation process feature vector obtained from the classification object data as input to the machine learning model, and by using a classification ratio vector list in which at least a second classification ratio vector different from a first classification ratio vector, being a correct answer to the classification object data, has been added to the first classification ratio vector as a correct answer to the input to the machine learning model.

5. A non-transitory computer-readable recording medium storing a program for causing a computer to perform the method of claim 4.
